(19) United States
(12) Patent Application Publication
(10) Pub. No.: US 2005/0246288 A1
(43) Pub. Date: Nov. 3, 2005

(54) Session information preserving system and method therefor

(75) Inventors: Daisuke Kimura, Kawasaki (JP); Mitsuhiko Yoshimura, Kawasaki (JP); Makoto Kitagawa, Kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: HITACHI, LTD., Tokyo (JP)

(21) Appl. No.: 11/019,413

(22) Filed: Dec. 20, 2004

(30) Foreign Application Priority Data
Apr. 28, 2004 (JP) 2004-132483

(51) Int. Cl. H04K 1/00

(52) U.S. Cl. 705/65

(57) ABSTRACT

A session-information preserving system includes a client to which business data are inputted and a server which processes the business data sent from the client computer. The system includes a login control component to execute a login procedure on the basis of user identification information necessary for logging in to said system; a maintenance management component to search a maintenance information table for maintenance information on said server; and a pane generator to generate data used to display a plurality of panes on the client, the pane data including the maintenance information that has been retrieved by the maintenance management component, the plurality of panes including first and second panes configured to be displayed on a display of the client to receive first information and second information, respectively, from the client that are to be stored in the server and a notification pane to display a notice relating to the maintenance information on the display of the client, the second information including a first portion and a second portion.

### CROSS-REFERENCES TO RELATED APPLICATIONS

This application claims priority to Japanese Patent Application No. 2004-132483, filed on Apr. 28, 2004.

### BACKGROUND OF THE INVENTION

The present invention relates to a session-information preserving system for online systems using networks.

With the development of network technologies such as the Internet, more and more processing tasks of industries are performed using web sites. Among various kinds of business data processing, the ones in particular using continuous forms are often used for placing orders in business to business transactions, inputting data of in-house systems, and so on. Since there are significant merits such as savings in labor and reduction of costs by utilizing electronic formats and web sites, Web packages for tasks using continuous forms are provided by many vendors and are commercially available. Since such Web application software handle enormous volumes of data, it is often the case to enter data while navigating through a plurality of pages shown by a browser. However, because stateless HTTP protocols are used in the Web application, a system for preserving a flow of a series of operations by a user is necessary, and SI vendors provide such systems of their own.

Japanese Unexamined Patent Publication No. 2003-6018 discloses a technology which urges input of an instruction to suspend processing and accepts such input when a failure on a server machine is detected.

### BRIEF SUMMARY OF THE INVENTION

In a system where data are entered online by using Web application, it is necessary to preserve session information for navigation over a plurality of pages by some method. Further, in large-scale Web application open to the public such as on-line shopping and on-line banking, during logging-in, when a system is shut down due to regular maintenance or emergency maintenance of a server and if a user is not notified of the system shutdown or the user does not recognize the system shutdown, processing performed by the user is interrupted and contents of the processing made thus far may be lost.

Also, it is a duty for a system administrator to consider details of the maintenance and what are affected by a shutdown of service, to examine a schedule for the shutdown, and to announce the shutdown of the service beforehand, which places heavy burden on the system administrator.

Further, JP No. 2003-6018 discloses a measure to be taken to cope with a failure on a server, which accepts an interruption of processing after an occurrence of the failure. Therefore, preservation of session information in the case of predetermined system shutdowns such as the one due to maintenance of a system is not taken into account.

One embodiment of the present invention provides a session-information preserving system in which contents of processing before shutdown can be maintained even when the system shuts down due to maintenance and so on.

In such a system, when maintenance information of a server is stored, window or pane data including the maintenance information is generated and a business-data entry window or pane is shown. Also, on the basis of the maintenance information, a maintenance warning window or pane is shown and session information of the entered data is stored.

As used herein, the term “pane” refers to a collection of data that are displayed on a screen or display area of the display device in an organized manner. An example of a pane is a window that displays information within a frame.

As used herein, the term “screen” is used also to refer to a pane as well as a display area of the display device.

Further, when a user logs in, if session information for the user is stored, a business-data entry screen including such session information is generated and shown.

According to the present invention, even when logging out due to a system shutdown caused by maintenance, etc., a user can preserve session information before the log-out. Further, the user can resume his or her processing in a state before the log-out when logging in again by retrieving the preserved session information.

One embodiment provides a session-information preserving system including a client to which business data are inputted and a server which processes the business data sent from the client computer. The system includes a login control component to execute a login procedure on the basis of user identification information necessary for logging in to said system; a maintenance management component to search a maintenance information table for maintenance information on said server; and a pane generator to generate data used to display a plurality of panes on the client, the pane data including the maintenance information that has been retrieved by the maintenance management component, the plurality of panes including first and second panes configured to be displayed on a display of the client to receive first information and second information, respectively, from the client that are to be stored in the server and a notification pane to display a notice relating to the maintenance information on the display of the client, the second information including a first portion and a second portion, wherein the notification pane is displayed on the client to provide information on a scheduled maintenance of the server while a user is inputting the first portion of the second information on the second pane, so that the user cane save the inputted first portion of the second information prior to the scheduled maintenance of the server, and wherein the second portion of the second information has not been inputted using the second pane and the first information has already been inputted using the first pane.

In another embodiment, an application server is coupled to a client and includes a login control unit to execute a login procedure on the basis of identification information of said user, the login procedure being executed upon receiving a user identification information from the client; a pane to generate unit generating a script corresponding to maintenance information of a maintenance information table and generate pane data including the script when the maintenance information of said server is stored in the maintenance information table, the maintenance information providing information as to when the server is to be serviced; and a computer storage medium including a session information table including an session object that is associated with a user identification information, the session object including business data input by a user according to a plurality of panes presented to the user on the client, the plurality of panes being generated using the pane data generated by the pane generator unit, wherein said login control unit searches, after the login procedure, said session information table for the session object corresponding to the user identification information received from the client for the login procedure, and wherein, when the session object corresponding to the user identification information is found, said screen generating unit generates pane data containing the session object.

In another embodiment, a session-information preserving method for a business operations system in which a client computer and a server are connected through a network is provided. The client computer shows a login screen on which user identification information is entered when logging in to said system. The method comprises executing a login procedure on said server on the basis of said user identification information entered on said login pane; searching a maintenance information table for maintenance information about maintenance of said server; generating pane data containing a script corresponding to the maintenance information when the maintenance information is found as a result of the search; and sending the generated screen pane to said client computer. Said client computer receives said pane data, shows a pane on which business data concerning said system are entered on the basis of the received pane data, shows a maintenance warning pane on the basis of information about the warning of maintenance contained in said maintenance information and, if it is chosen to preserve the business data already entered when the warning of maintenance is shown, sends session information about the business data to said server. Said server receives the session information sent from said client computer, links the session information with the user identification information corresponding to said login procedure, and stores it in a session information table.

In yet another embodiment, a computer readable medium including a program to be executed in a business operations system which includes a client computer operated by a user and a server connected with the client computer and storing business data is provided. The program comprises code for executing a login procedure on the basis of identification information of said user; code for storing maintenance information of said server in a maintenance table; code for creating a script corresponding to the maintenance information stored in the maintenance information table; code for generating pane data including the script; code for linking, in accordance with the maintenance information of said server, session information corresponding to the business data entered on the pane shown according to said generated screen data with the user identification information used for said login procedure and stores it in a session information table; code for searching, after said login procedure, said session information table for the session information linked with the user identification information corresponding to the login procedure; and code for generating pane data including the session information when the session information corresponding to the user identification information is stored.

In yet another embodiment, a session-information preserving method in a system including a client to which business data are inputted and a server which processes the business data sent from the client computer is provided. The method comprises executing a login procedure using a login control component on the basis of user identification information necessary for logging in to said system; searching a maintenance information table for maintenance information on said server; and generating pane data used to display a plurality of panes on the client, the pane data including the maintenance information that has been retrieved, the plurality of panes including first and second panes configured to be displayed on a display of the client to receive first information and second information, respectively, from the client that are to be stored in the server and a notification pane to display a notice relating to the maintenance information on the display of the client, the second information including a first portion and a second portion. The notification pane is displayed on the client to provide information on a scheduled maintenance of the server while a user is inputting the first portion of the second information on the second pane, so that the user can save the inputted first portion of the second information prior to the scheduled maintenance of the server. The second portion of the second information has not been inputted using the second pane and the first information has already been inputted using the first pane.

### BRIEF DESCRIPTION OF THE DRAWINGS

FIG. 1 shows a block diagram of a Web system, which is one embodiment of the present invention.

FIG. 2 shows a data structure of a session information table 161.

FIG. 3 shows a data structure of a maintenance information table 162.

FIG. 4 shows a data structure of a user information table 163.

FIG. 5 shows a structure of HTTP data 11 to be sent from an application server 100 to a user's client computer 1100.

FIG. 6 is a flowchart of processing when registering maintenance information.

FIG. 7 is a flowchart of processing when logging in to a system and entering business data.

FIG. 8 is a flowchart of processing when preserving user's session before a maintenance time.

FIG. 9 is a screen transition diagram when entering business data.

FIG. 10 is a screen transition diagram when entering maintenance information of the system.

### DETAILED DESCRIPTION OF THE INVENTION

With reference to the drawings, embodiments of the present invention will now be described.

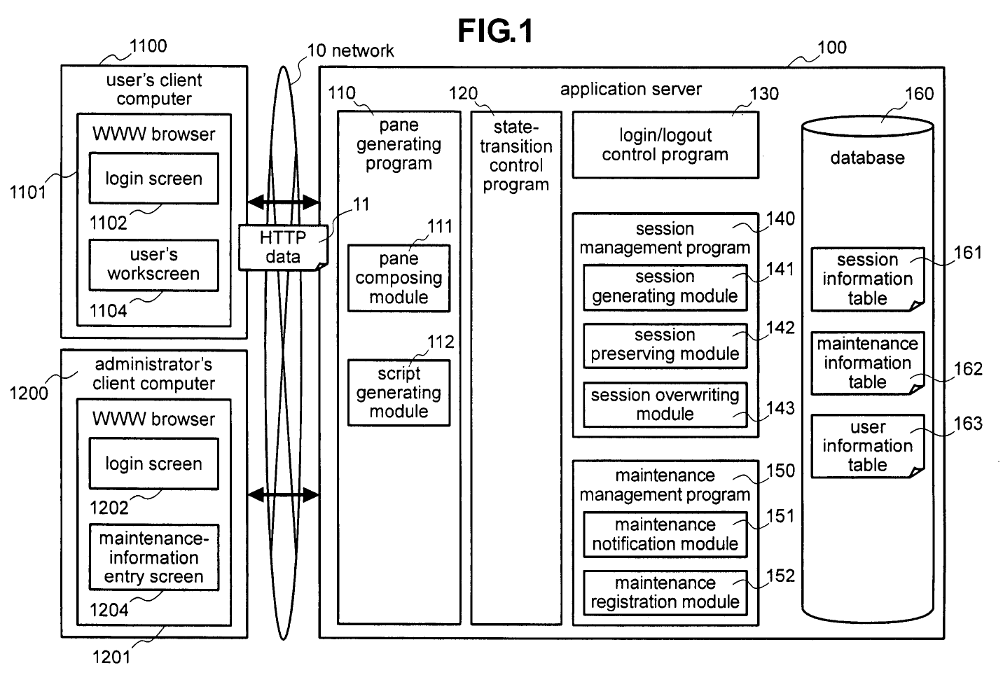

FIG. 1 shows a detailed structure of the session-preserving system according to one embodiment of the present invention.

A user's client computer 1100 and an administrator's client computer 1200 are terminals communicating with an application server 100 and are connected through a network 10. The user's client computer 1100 communicates with the application server 100 and inputs data. The administrator's client computer 1200 communicates with the application server 100 and inputs maintenance information of the application server 100. The server 100 is a business-application system which accepts input of business data through a network such as the Internet and processes data.

The application server 100 includes a screen generating program 110, a state-transition control program 120, a login/logout control program 130, a session management program 140, and a maintenance management program 150, which run within the application server 100.

The state-transition control program 120 receives data sent from the user's client computer 1100 or the administrator's client computer 1200. The data received are user identification information (user IDs and passwords) to be used for logging in, business data, maintenance information, and so on.

Being based on user information sent from the user's client computer 1100 or the administrator's client computer 1200, the login/logout control program 130 controls logging in to and out of a system.

A database 160 in the application server 100 contains a session information table 161 for storing session objects uniquely corresponding to user IDs of users logging in to the system, a maintenance information table 162 storing information about maintenance of the application server 100, and a user information table 163 storing user IDs and passwords.

A screen composing module 111 and a script generating module 112 are program components which function under the screen generating program 110. The screen composing module 111 and the script generating module 112 create HTTP data 11 which are sent to a WWW browser of the user's client computer 1100 or the administrator's client computer 1200.

A session generating module 141, a session preserving module 142, and a session overwriting module 143 are all program components which function under the session management program 140. The session generating module 141 generates session objects storing information about screen transition during logging-in of the user and inputted values. When the server is shut down, the session preserving module 142 stores session objects to be used by the user in the session information table 161. After the shutdown of the application server 100, when the user logs in, the session overwriting module 143 retrieves a session object corresponding uniquely to the user from the session information table 161.

A maintenance notification module 151 and a maintenance registration module 152 are both program components which function under the maintenance management program 150. The maintenance notification module 151 is called up by the script generating module 112, retrieves detailed information about maintenance from the maintenance information table 162, and sends data back to the script generating module 112. The maintenance registration module 152 stores the detailed information 171 about the maintenance, a parameter inputted by the administrator's client computer 1200, in the maintenance information table 162.

A WWW browser 1101 is a program which runs on the user's client computer 1100, and conducts data communications with the application server 100 through a network 10. A login screen 1102 is a screen shown when the user logs in, and a user's workscreen 1104 is a screen shown in the WWW browser 1101 on which the user enters data for a business application.

A WWw browser 1201 is a program which runs on the administrator's client computer 1200, and conducts data communications with the application server 100 through the network 10. A login screen 1202 is a screen shown when the administrator logs in, and a maintenance-information entry screen 1204 is a screen shown in the browser 1201 on which the administrator enters maintenance information.

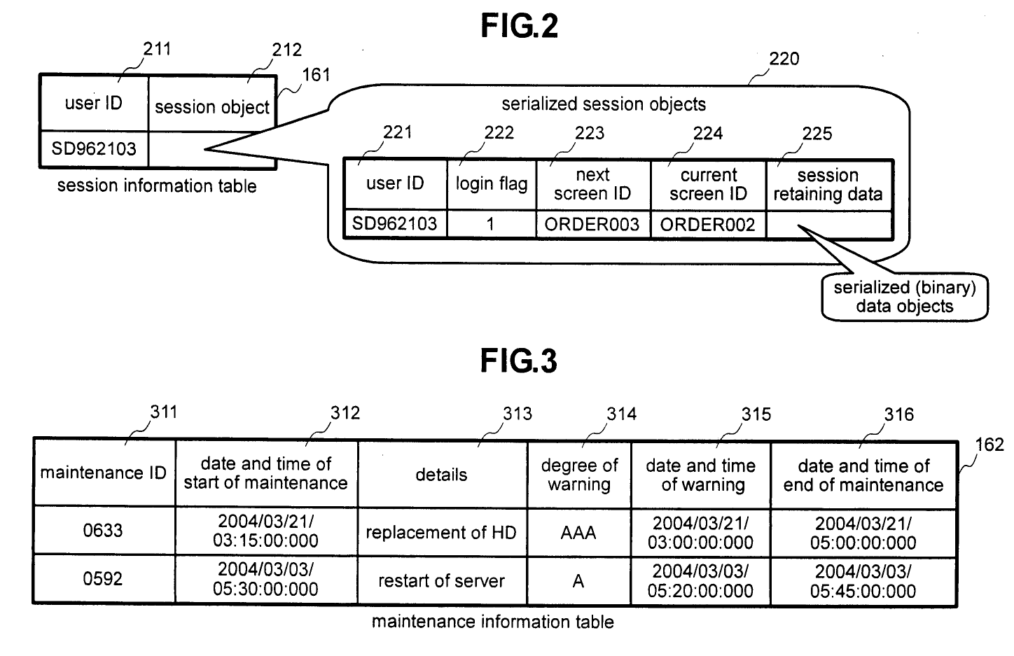

FIG. 2 shows a data management structure of the session information table 161 of the database 160 in the application server 100 according to one embodiment. Namely, FIG. 2 shows a structure of session data which is a data format used when session information of the user is preserved.

The session information table 161 includes a user ID column 211 identifying users and a session object column 212 corresponding to user IDs one by one. The session object column 212 holds session objects 220 generated by the application server 100 as binary data. The session objects 220 includes a user ID 221, a login flag 222 showing whether a user is logging in or logging out, an original screen ID 224, which is an ID of a screen where the user was at work when storing data, and a next screen ID 223 which is an ID of a screen after transition, and session retaining data 225 storing contents inputted by the user as session information.

FIG. 3 shows a data management structure of the maintenance information table 162 in the data base 160 of the application server 100 according to one embodiment.

The maintenance information table 162 stores maintenance IDs 311 each of which is an identification number identifying each maintenance uniquely, date and time 312 of starting maintenance, details of maintenance 313, degree of warning 314, date and time of warning 315, and date and time of ending maintenance 316.

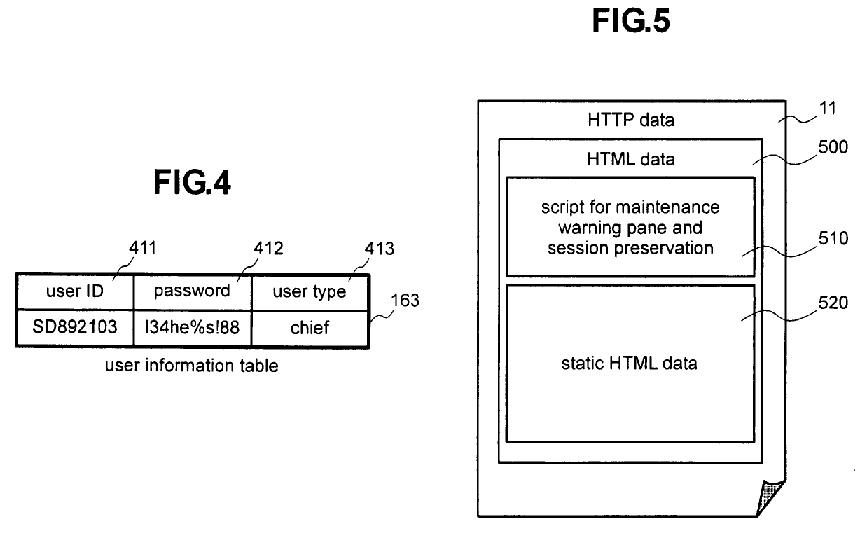

FIG. 4 shows a data management structure of the user information table 163 in the database 160 of the application server 100 according to one embodiment. The user information table 163 stores a user ID 411, a password 412 uniquely corresponding to the user ID 411, and a user type 413 indicating a user's title, a section in his or her charge, etc. The user ID 411 and the password 412 stored in the user information table 163 are identification information identifying the user when the user logs in to the system and, on the basis of such information inputted during the login, the login/logout control program 130 refers to the user information table 163 and executes a login procedure.

FIG. 5 shows a data structure sent from the application server 100 to the user's client computer 1100 according to one embodiment. In the present embodiment, a case when HTTP data 11 is sent will be described.

HTML data 500 are stored in the HTTP data 11. The HTML data 500 includes a script 511 containing a logic for showing a warning screen in conjunction with the server maintenance and preserving session information, and static HTML data 512 for page design.

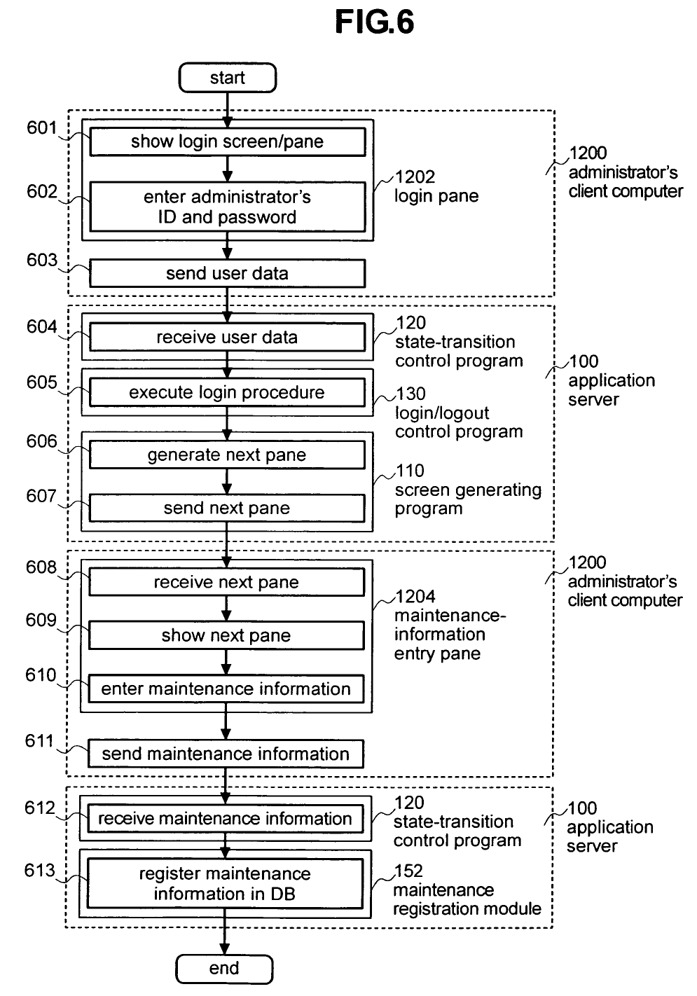

FIG. 6 is a flowchart showing a process when the application server 100 registers system maintenance information sent from the administrator's client computer 1200 according to one embodiment.

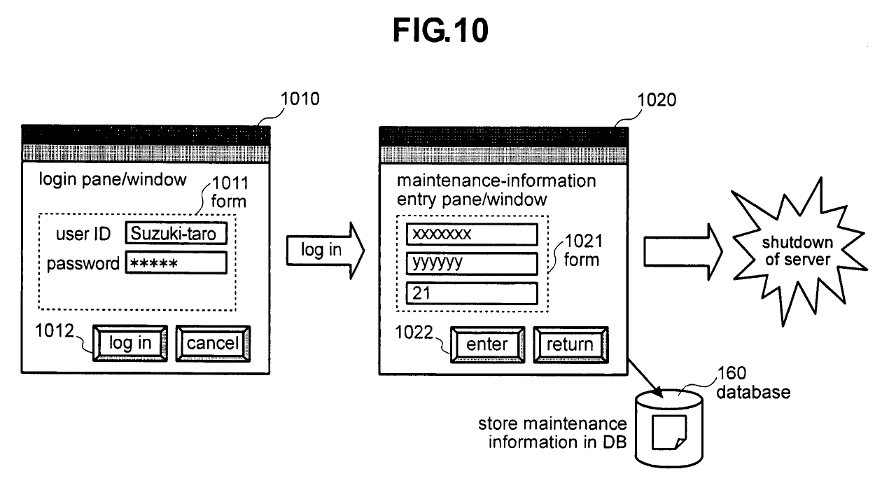

First, the administrator's client computer 1200 shows the login screen 1202 on the WWW browser 1201 (step 601). The login screen is sent from the application server 100 through the network 10. The details of the login screen will be described later in FIG. 10. Next, the administrator's client computer 1200 accepts, on the login screen 1202, input of an administrator's ID and a password, which are identification information of the administrator necessary for the log-in (step 602). In step 602, when a system administrator enters a user ID and a password and presses a login button, the administrator's client computer 1200 sends data inputted in step 602 to the application server 100 (step 603).

Then, the state-transition control program 120 of the application server 100 receives the inputted data sent from the administrator's client computer 1200 (step 604). Being based on the received data, the login/logout control program 130 refers to the user information table 163 stored in the database 160 for user information, performs user authentication of the system, and executes a login procedure (step 605). After the login procedure, the screen generating program 110 of the application server 100 generates a maintenance-information entry screen 1204 (step 606), and the application server 100 sends data of the generated maintenance-information entry screen 1204 to the administrator's client computer 1200 (step 607).

Then, the administrator's client computer 1200 receives the data of the maintenance-information entry screen 1204 sent from the application server 100 (step 608), and the WWW browser 1201 displays page data of the received maintenance-information entry screen 1204 (step 609). The administrator's client computer 1200 accepts information about maintenance to be entered on the displayed maintenance-information entry screen 1204 (step 610). Information to be inputted includes a maintenance ID 311, date and time of starting maintenance 312, details of maintenance 313, degree of warning 314, date and time of warning 315, date and time of ending maintenance 316, and so on. The system administrator enters information about maintenance on the maintenance-information registration screen 1204. The administrator's client computer 1200 sends the maintenance information inputted in step 610 to the application server 100 (step 611).

Then, the state-transition control program 120 of the application server 100 receives the maintenance information (step 612) sent in step 611; and a maintenance registration module 152 of the maintenance management program 150 stores the received maintenance information in the maintenance information table 162 of the database 160 (step 613)

By conducting the above processing, the maintenance information of the system is registered in the application server.

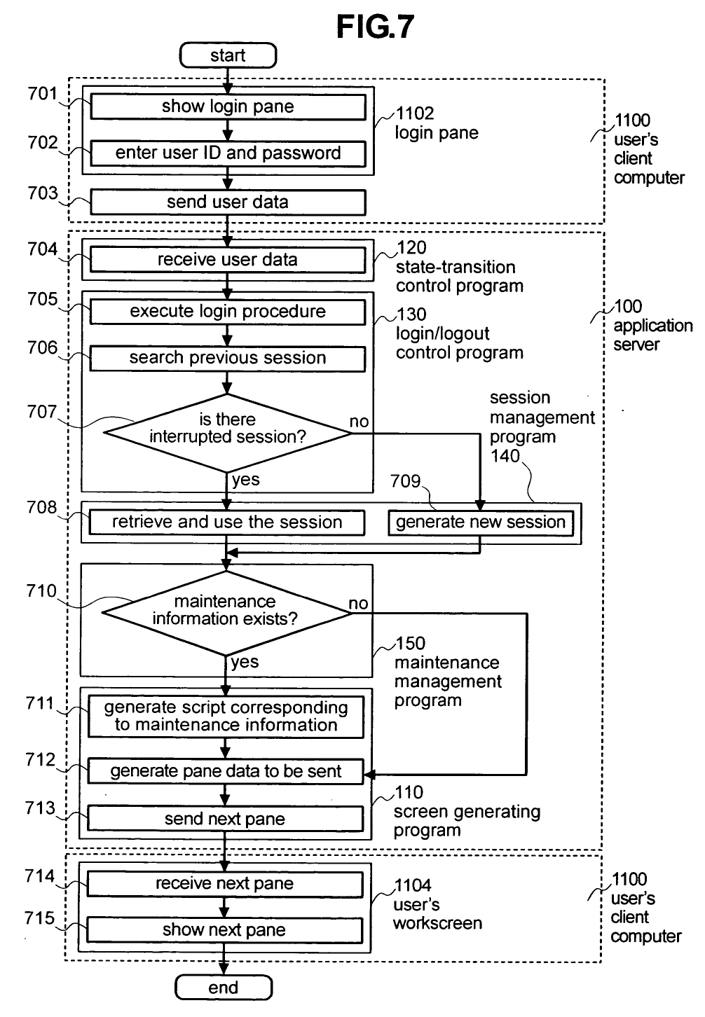

FIG. 7 is a flowchart of processing when a user logs in to the system and enters business data according to one embodiment.

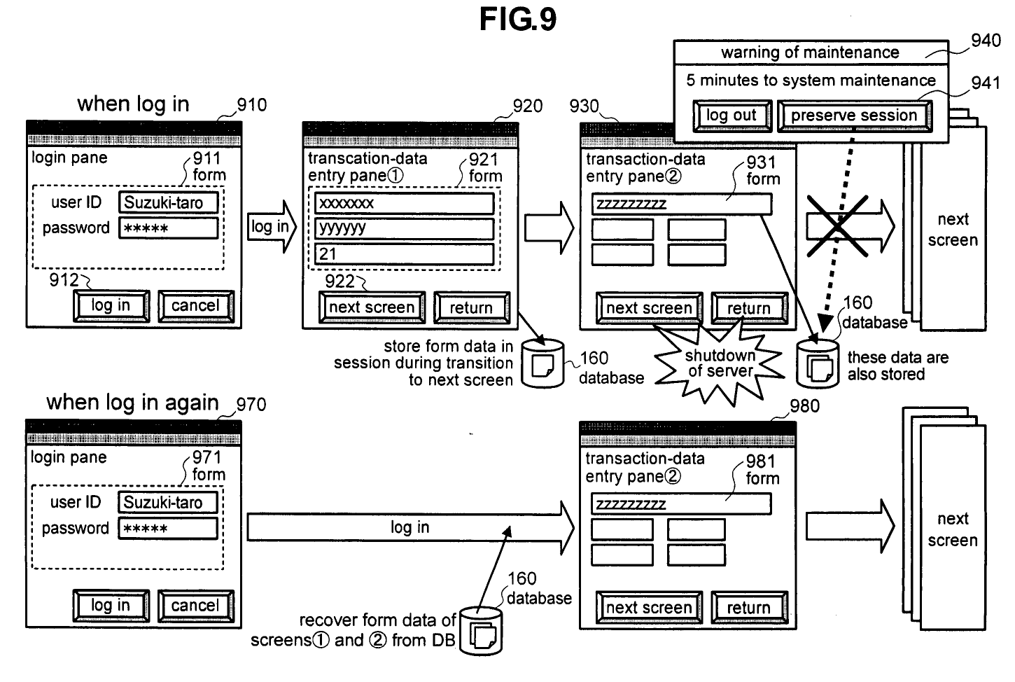

The WWW browser 1101 of the user's client computer 1100 shows a login screen sent from the application server 100 (step 701). The details of the login screen on this occasion will be described later with reference to FIG. 9. The WWW browser 1101 of the user's client computer 1100 accepts, on the login screen 1102, entry of a user ID and a password which are user identification information necessary for a login procedure (step 702). In step 702, when the user enters the user ID and password and presses a login button, the user's client computer 1100 sends the entered user ID and password to the application server 100 (step 703).

The state-transition control program 120 of the application server 100 receives the user ID and password sent in step 703 from the user's client computer 1100 (step 704). On the basis of the data received in step 704, the login/logout control program 130 refers to the user information table 161 of the database 160 for user information, performs user authentication of the system, and executes a login procedure (step 705).

Then, the login/logout control program 130 searches the session table 161 stored in the database 160 (step 706). Using a user ID 211 as key information, the login/logout control program 130 searches for a session object 212 corresponding to the user ID. After the search in step 706, when there is session information about an interruption of processing due to the previous maintenance (step 707; yes), a session overwriting module 143 of a session management program 140 obtains the session object 212 from the session information able 161, and retrieves data 225 out of the object (step 708). When there is no relevant session data found in step 707 (step 707: no), the session generating module 141 in the session management program 140 newly generates a session object (step 709).

Then, a maintenance management program 150 of the application server 100 searches a maintenance information table 162 of the database 160 for maintenance information (step 710). When there is maintenance information, a maintenance notification module 151 of the maintenance management program 150 sends the maintenance information to a script generating module 112 of a screen generating program 110, and the script generating module 112 generates a script according to the maintenance information (step 711).

The script generating module 112 generates a script 510 to be embedded in HTML data 500 (FIG. 5) to be sent to the user's client computer 1100. In order to generate the script 510, date and time of starting maintenance 312, details of maintenance 313, degree of warning 314, and date and time of warning 315 (FIG. 3), which are all included in the maintenance information stored in the maintenance information table 162 (FIG. 3), are used. Then, using such information, a warning screen for the user is shown a certain time before starting maintenance (date and time of warning 315), and such a script 510 as to store data being processed according to the choice of the user is created. Further, when there is no maintenance information found in step 710 (step 710: no), the screen generating program 110 creates such a script as not to include maintenance information, and generates a screen according to the script (business-data entry screen).

Then, on the basis of the script 510 generated by the script generating module 112, the screen composing module 111 generates HTML data 500 about a screen to be shown on the user's client computer 1100 (step 712). The screen composing module 111 generates the HTML data 500 (FIG. 5) by embedding the script 510 generated by the script generating module 112 and static HTML data 520. Further, the screen composing module 111 embeds a value of the session object 225 (FIG. 2) in the form in the HTML data 500.

Further, when there is no maintenance information found in the maintenance information table 162 (step 710: no), the processing in FIG. 7 advances to step 712; and the screen composing module 111 generates only the HTML data 500 to be displayed on the user's client computer 1100 and embeds the value of the session object 225 in the form in the HTML data 500.

Next, the application server 100 sends the HTML data 500, which is the data for screen to be sent generated in step 721, to the user's client computer 1100 as HTTP data 11 (step 713). Then, the user's client computer 1100 receives the HTTP data 11 sent from the application server 100 (step 714). Further, on the basis of the HTTP data 11 received in step 714, the WWW browser 1101 of the application server 100 produces a user's workscreen 1104 (step 715).

By performing the above processing, a user can enter business data on the user's workscreen 1104 shown there. Also, when the user logs in to the system, if the session information preserved before and corresponding to the user is stored (step 707: yes), the user can continue using it.

Further, when maintenance information is stored in the maintenance information table 162, the screen generating program 110 creates a screen script corresponding to the maintenance information (step 711). Therefore, it serves the purpose if the system administrator stores information about maintenance of the server in the system, and there is no need to notify the user logging in to the system of the maintenance information, reducing the burdens on the administrator.

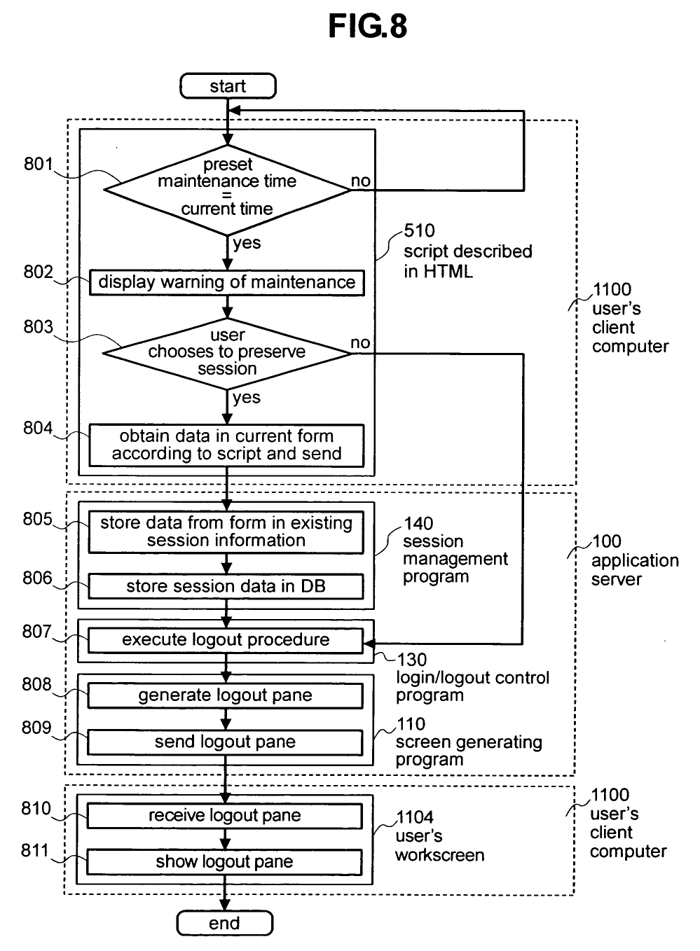

FIG. 8 is a flowchart of preserving the user's session when the starting time of the maintenance of the system is nearing (at a prescribed time before the system maintenance). As shown in FIG. 7, when the user has logged in to the system and entering business data, the user's workscreen 1104 is shown in step 715. The user's workscreen 1104 is produced on the basis of the HTTP data 11 (FIG. 5) sent from the application server 100 to the user's client computer 100. Therefore, the HTTP data 11 includes the HTML data 500, which includes the script 510.

In FIG. 8, first, when loaded into the WWW browser 1101, the script 510 of the HTML data 500 compares the data and time of warning 315 described in the script 510 with a system time of the user's client computer 1100 (step 801). As a result of the comparison, when the date and time of warning 315 in the script 510 and the system time of the user's client computer 1100 are the same (step 801: yes), the user's client computer 1100 gives a warning to the user informing that it is a prescribed time before the system maintenance by using a pop-up screen, etc. (step 802).

On the pop-up screen, etc. shown in step 802, the user's client computer 1100 urges the user to choose whether or not to preserve a session at that moment (step 803). When the user chooses to preserve the session in step 803 (step 803: yes), the script 510 obtains data already entered on the user's workscreen 1104, and the user's client computer 1100 sends the entered data to the application server 100 (step 804).

Then, the application server 100 receives the entered data sent from the user's client computer 1100 (step 805), and a session preserving module 142 links the data received in step 805 with the user ID 211 to prepare a session object 212 and stores it in the session information table 161 of the database 160 (step 806).

Further, when the user chooses not to preserve the session in step 803 (step 803: no), the processing advances to step 807 (a logout procedure). Namely, according to the flowchart of FIG. 8, when the user chooses not to preserve the session, the business data entered so far are not preserved and the logout procedure is executed.

However, such a configuration may be adopted that if the user chooses not to preserve the session in step 803 and when business data have been entered on two or more screens, session information corresponding to the business data already entered on screens before the current screen may be preserved and are stored in the session information table 161. This configuration is also useful for a user who need not preserve data entered on the current screen but wishes to preserve data already entered on the preceding screens.

Then, the login/logout control program 130 executes a logout procedure of the user (step 807). The screen generating program 110 generates screen data after the logout to be sent to the user's client computer 1100 (step 808), and sends HTTP data 11 containing the generated screen data to the user's client computer 1100 (step 809).

The user's client computer 1100 receives the HTTP data 11 sent from the application server 100 and receives the screen after log-out stored in the HTTP data 11 (step 810). The WWW browser 1101 shows the received screen data after log-out (step 811).

The above processing makes it possible to store session data of a logging-in user in a database a prescribed time before maintenance of the application server and to have the user log out automatically.

FIG. 9 shows examples of screens shown on the user's client computer 1100 in the processing in FIGS. 7 to 8 according to one embodiment.

The user's client computer 1100 shows a login screen 910 (step 701 in FIG. 7). When a user ID and a password are entered into a form 911 (step 702) and a login button 912 is pressed, the processing moves on to a transaction-data entry screen 920.

In another embodiment, the data entered by the user is saved at the client side until the user has finished entering all data for the session. That is, the data entered are not transmitted to the database 160 until the user has finished entering the data in connection with the last pane of the session and indicates that all data are to be saved in the database 160.

The user's client computer 1100 shows the transaction-data entry screen 920 (which corresponds to user's workscreen 1104 in FIG. 1). When the user enters business information into a form 921 on the screen 920 and presses a next-screen button 922, a session entered on the screen 920 is sent to the application server 100 and stored in the database 160. Namely, in the example of FIG. 9, every time a new screen is shown, information entered on the screen (session information) is stored in the database 160.

If a prescribed time before maintenance of the server comes when data entry into the form 931 on the next screen 930 hasn't completed, namely, when the date and time 315 of warning for maintenance comes (step 801 in FIG. 8: yes), the script 510 sent to the user' client computer 1100 shows a maintenance warning screen 940 (step 802 in FIG. 8). When the user presses a button 941 for preserving the session (step 803: yes), the script 510 sends the data in the form 931 to the application server 100 (step 804 in FIG. 8).

The session management program 140 of the application server 100 merges the above data with the session data already entered on the preceding screens (session data already kept in the database 160), links it with the user ID, and stores it in the database 160 (step 806 in FIG. 8). Also, after this processing, the login/logout control program 130 has the user automatically log out (step 807 in FIG. 8).

After the system maintenance, when the user enters user information into a form 971 on a login screen 970 and logs in again, the login/logout control program 130 calls up the session management program 140, and obtains session data 225 linked with the user ID from the database 160 (step 707 in FIG. 7). The screen generating program 110 generates an image with data embedded in a form 981 by using the obtained session data 225. The generated screen is shown on the user's client computer 1100 as a screen 980 (step 708 of FIG. 7).

Thus, the user retrieves contents of the processing on the basis of the session information previously preserved, and can proceed with the rest of the processing. Namely, including data being entered during the system shutdown due to the server maintenance, the session information is stored in the session information table. Therefore, the user can resume processing as it was at the end of the last entry operation when logging in again.

In FIG. 9, the user gains access to the application server 100 through the user's client computer 1100 according to one embodiment. Every time the application server 100 receives a page request from the user's client computer 1100, it obtains maintenance information from the database 160 by using the maintenance management program 150. The screen generating program 110 generates a screen by inserting maintenance information in the script 510, and the application server 100 sends the generated image to the user's client computer 1100. Thus, by dynamically inserting the maintenance information of the server into the HTML file, a session at a prescribed time before the maintenance can be automatically preserved. Further, a management method in a mission-critical web system can be simplified and session data can be preserved.

FIG. 10 shows examples of screens shown on the administrator's client computer 1200 when the maintenance information is registered in FIG. 6 according to one embodiment.

When the login screen 1202 is shown on the administrator's client computer (step 601 in FIG. 6), the system administrator enters user information (a user ID and a password) into a form 1011 on a login screen 1010 (step 602 in FIG. 6). Then, when a login button 1012 is pressed, a maintenance-information entry screen 1020 is shown. On the maintenance-information entry screen 1020, the system administrator enters maintenance information such as a maintenance ID 311, date and time of starting maintenance 312, and date and time of warning 315 into a form 1021, and presses an entry button 1022. Accordingly, the maintenance management program 150 of the application server 100 stores the maintenance information entered on the screen 1020 in the maintenance table 162 of the database 160.

The present invention has been described in terms of specific embodiments to illustrate the invention to those skilled in the art. The above embodiments may be changed or modified without departing from the scope of the present invention. Accordingly, the scope of the invention should be defined using the appended claims.

1. A session-information preserving system including a client to which business data are inputted and a server which processes the business data sent from the client computer, said system comprising:
a login control component to execute a login procedure on the basis of user identification information necessary for logging in to said system;
a maintenance management component to search a maintenance information table for maintenance information on said server; and
a pane generator to generate data used to display a plurality of panes on the client, the pane data including the maintenance information that has been retrieved by the maintenance management component, the plurality of panes including first and second panes configured to be displayed on a display of the client to receive first information and second information, respectively, from the client that are to be stored in the server and a notification pane to display a notice relating to the maintenance information on the display of the client, the second information including a first portion and a second portion,
wherein the notification pane is displayed on the client to provide information on a scheduled maintenance of the server while a user is inputting the first portion of the second information on the second pane, so that the user cane save the inputted first portion of the second information prior to the scheduled maintenance of the server, and
wherein the second portion of the second information has not been inputted using the second pane and the first information has already been inputted using the first pane.

2. The system of claim 1, wherein the first information and the inputted first portion of the second information are stored in a session information table maintained by the server, the session information table storing information inputted via the plurality of panes as a session object, the session object including the first information and the inputted first portion of the second information.

3. The system of claim 2, wherein said login control component is operable to search said session information table for a session object corresponding to the user identification information used in the login procedure, so that the session object corresponding to the user identification information can be displayed on the client after initiating a subsequent login procedure using the user identification information.

4. The system of claim 3, wherein the subsequent login procedure occurs after the scheduled maintenance of the server has been completed, wherein the server causes the second pane to be displayed on the client with the first portion of the second information already included in the second plane, so that the user can commence entering the second portion of the second information without reentering the first portion of the second information.

5. The system of claim 1, wherein said pane generating component comprises a script generating unit to generate scripts for displaying the notification pane at the client and a pane composing unit to generate panes to receive inputs from the user.

6. The system of claim 1, further comprising:
a session management component to receive the first portion of the second information inputted on the second pane in response to the notification pane and save the first portion in the session information table.

7. An application server coupled to a client, the server comprising:
a login control unit to execute a login procedure on the basis of identification information of said user, the login procedure being executed upon receiving a user identification information from the client;
a pane to generate unit generating a script corresponding to maintenance information of a maintenance information table and generate pane data including the script when the maintenance information of said server is stored in the maintenance information table, the maintenance information providing information as to when the server is to be serviced; and
a computer storage medium including a session information table including an session object that is associated with a user identification information, the session object including business data input by a user according to a plurality of panes presented to the user on the client, the plurality of panes being generated using the pane data generated by the pane generator unit,
wherein said login control unit searches, after the login procedure, said session information table for the session object corresponding to the user identification information received from the client for the login procedure, and
wherein, when the session object corresponding to the user identification information is found, said screen generating unit generates pane data containing the session object.

8. The server of claim 7, wherein said maintenance information includes when to display a notification of maintenance on the client.

9. The server of claim 8, where the maintenance information includes a maintenance identifier and the date and time of scheduled maintenance.

10. A session-information preserving method for a business operations system in which a client computer and a server are connected through a network;
wherein said client computer shows a login screen on which user identification information is entered when logging in to said system, the method comprising:
executing a login procedure on said server on the basis of said user identification information entered on said login pane;
searching a maintenance information table for maintenance information about maintenance of said server;
generating pane data containing a script corresponding to the maintenance information when the maintenance information is found as a result of the search; and
sending the generated screen pane to said client computer,
wherein said client computer receives said pane data, shows a pane on which business data concerning said system are entered on the basis of the received pane data, shows a maintenance warning pane on the basis of information about the warning of maintenance contained in said maintenance information and, if it is chosen to preserve the business data already entered when the warning of maintenance is shown, sends session information about the business data to said server, and
wherein said server receives the session information sent from said client computer, links the session information with the user identification information corresponding to said login procedure, and stores it in a session information table.

11. A session-information preserving method according to claim 10,
wherein said server embeds the session information in said pane data and sends it to said client computer when the session information linked with the user identification information corresponding to said login procedure is stored in said session information table.

12. A session-information preserving method according to claim 10, wherein said server executes a logout procedure of a user corresponding to user identification information after linking said session information with the user identification information corresponding to said login procedure and storing it in the session information table.

13. A computer readable medium including a program to be executed in a business operations system which includes a client computer operated by a user and a server connected with the client computer and storing business data, the program comprising:
code for executing a login procedure on the basis of identification information of said user;
code for storing maintenance information of said server in a maintenance table;
code for creating a script corresponding to the maintenance information stored in the maintenance information table;
code for generating pane data including the script;
code for linking, in accordance with the maintenance information of said server, session information corresponding to the business data entered on the pane shown according to said generated screen data with the user identification information used for said login procedure and stores it in a session information table;
code for searching, after said login procedure, said session information table for the session information linked with the user identification information corresponding to the login procedure; and
code for generating pane data including the session information when the session information corresponding to the user identification information is stored.

14. A session-information preserving method in a system including a client to which business data are inputted and a server which processes the business data sent from the client computer, said method comprising:
executing a login procedure using a login control component on the basis of user identification information necessary for logging in to said system;
searching a maintenance information table for maintenance information on said server; and
generating pane data used to display a plurality of panes on the client, the pane data including the maintenance information that has been retrieved, the plurality of panes including first and second panes configured to be displayed on a display of the client to receive first information and second information, respectively, from the client that are to be stored in the server and a notification pane to display a notice relating to the maintenance information on the display of the client, the second information including a first portion and a second portion,
wherein the notification pane is displayed on the client to provide information on a scheduled maintenance of the server while a user is inputting the first portion of the second information on the second pane, so that the user can save the inputted first portion of the second information prior to the scheduled maintenance of the server, and
wherein the second portion of the second information has not been inputted using the second pane and the first information has already been inputted using the first pane.

15. The method of claim 14, wherein the first information and the inputted first portion of the second information are stored in a session information table maintained by the server, the session information table storing information inputted via the plurality of panes as a session object, the session object including the first information and the inputted first portion of the second information.

16. The system of claim 15, wherein said login control component is operable to search said session information table for a session object corresponding to the user identification information used in the login procedure, so that the session object corresponding to the user identification information can be displayed on the client after initiating a subsequent login procedure using the user identification information.

17. The method of claim 16, wherein the subsequent login procedure occurs after the scheduled maintenance of the server has been completed, wherein the server causes the second pane to be displayed on the client with the first portion of the second information already included in the second plane, so that the user can commence entering the second portion of the second information without reentering the first portion of the second information.
